(19) United States
(12) Patent Application Publication
(10) Pub. No.: US 2004/0042446 A1
(43) Pub. Date: Mar. 4, 2004

(54) Maintaining routing information in a passive optical network

(76) Inventors: Christopher D. Koch, Minneapolis, MN (US); Duane M. Butler, Anoka, MN (US); Steven G. Knight, Saint Paul, MN (US); Milton J. Johnson, Lakeville, MN (US)

Correspondence Address: SHUMAKER & SIEFFERT, P. A., 8425 SEASONS PARKWAY, SUITE 105, ST. PAUL, MN, 55125, US

(21) Appl. No.: 10/449,854

(22) Filed: May 30, 2003

Related U.S. Application Data
(60) Provisional application No. 60/386,129, filed on May 31, 2002.

(51) Int. Cl. H04L 12/66; H04J 3/16

(52) U.S. Cl. 370/352; 370/465

(57) ABSTRACT

In general, the disclosure presents techniques for creating and maintaining routing information within a passive optical network. A PON interface receives a DHCP request to obtain a network address from a client represented by a node. The PON interface maps a particular interface module on which the client resides to unique client information, e.g., a media access control (MAC) address or other identifier, included in the DHCP request. The PON interface forwards the request to a DHCP server that returns a DHCP response indicating an administered IP address and lease time for the requesting client. Upon receipt of the DHCP response, the PON interface updates the mapping to create routing information for routing packets to the administered addresses. For example, PON interface may map the administered IP address to the particular interface module on which the client resides.

This application claims priority from U.S. Provisional Application Serial No. 60/386,129, filed May 31, 2002, the entire content of which is incorporated herein by reference.

### TECHNICAL FIELD

The invention relates to computer networking and, more particularly, to the maintenance of routing information within a passive optical network (PON).

### BACKGROUND

A passive optical network (PON) can deliver voice, video and other data among multiple network nodes using a common optical fiber link. Passive optical splitters and combiners enable a number of network nodes to share the optical fiber link. Each network node terminates the optical fiber link for a residential or business subscriber, and is sometimes referred to as a subscriber premises node. A PON typically includes a PON interface having multiple, independent PON interface modules that serve multiple optical fiber links. In the case of data services, the PON interface receives data packets from an Internet Service Provider (ISP) for transmission to network nodes.

### SUMMARY

In general, the invention is directed to techniques for creating and maintaining routing information within a passive optical network (PON). More specifically, a PON interface monitors communications between clients and one or more servers and generates routing information that associates the clients with respective PON interface modules of the PON interface based on the monitored communications. The routing information may, for example, associate network addresses leased to the clients by the servers with associated PON interface modules. The PON interface routes the traffic within the PON in accordance with the generated routing information.

For example, the PON interface may receive a Dynamic Host Configuration Protocol (DHCP) request to obtain a network address from a client represented by a network node within the PON. The PON interface maps a particular interface module on which the client resides to unique client information, e.g., a media access control (MAC) address or other identifier, included in the DHCP request. The PON interface forwards the request to a DHCP server, which returns a DHCP response indicating an administered Internet Protocol (IP) address and lease time for the requesting client. Upon receipt of the DHCP response, the PON interface updates the mapping to create routing information for routing packets to the administered IP addresses.

In one embodiment, the invention provides a method comprising monitoring communications between one or more servers and clients of a passive optical network, generating routing information to associate each of the clients with respective interface modules of a passive optical network interface based on the monitored traffic, the passive optical network interface communicatively coupling the servers and the clients, and routing traffic within the passive optical network in accordance with the generated routing information.

In another embodiment, the invention provides an interface for coupling one or more servers to clients within a passive optical network, the interface comprising a plurality of interface modules to transmit information to the clients via a plurality of optical fiber links, each of the interface modules corresponding to a particular one of the optical fiber links, and routing information that associates each of the clients with respective ones of the interface modules in order to route traffic to the clients, wherein the interface monitors communications between the clients and the servers in order to generate the routing information.

In a further embodiment, the invention provides a passive optical network comprising a plurality of network nodes to provide passive optical network services to one or more clients, at least one server to assign network addresses to the clients of the network nodes, an interface that includes a plurality of interface modules to transmit information to subsets of the network nodes, wherein the interface includes routing information that associates each of the interface modules with the clients of the respective subsets of network nodes.

The invention may provide one or more advantages. In particular, the invention operates in accordance with Layer 3, i.e., the network layer, routing information to provide the PON with more efficient routing. Layer 2 information, i.e., data link layer information, does not need to be carried across PON 10. Also, this technique enables the use of Layer 3 security methods, and lower cost switching methods associated with Layer 3 switching and routing. In addition, the technique provides ease of administration because Layer 2 methods of routing, such as Virtual Local Area Network (VLAN) tagging, are not required. The techniques further allow for non-repudiation of traffic origination, and isolation of IP traffic anomalies to a specific interface. In general, for a PON access network using DHCP Boot-Relay for IP address assignment to clients, this technique provides a way for the access network to establish DHCP IP address routing information to specific PON interface modules.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating a passive optical network (PON).

FIG. 2 is a block diagram illustrating a PON in which groups of network nodes couple to a PON interface that includes multiple PON interface modules, each with a corresponding Dynamic Host Configuration Protocol (DHCP) relay agents.

FIG. 3 is a block diagram illustrating a PON in which groups of network nodes couple to a PON interface that includes multiple PON interface modules, each of which corresponds to a common DHCP relay agent.

FIG. 4 is a flowchart illustrating interaction of various PON components to create and maintain routing information in accordance with the invention.

FIG. 5 is a flowchart illustrating an exemplary mode of operation of a PON interface handling an inbound packet.

### DETAILED DESCRIPTION

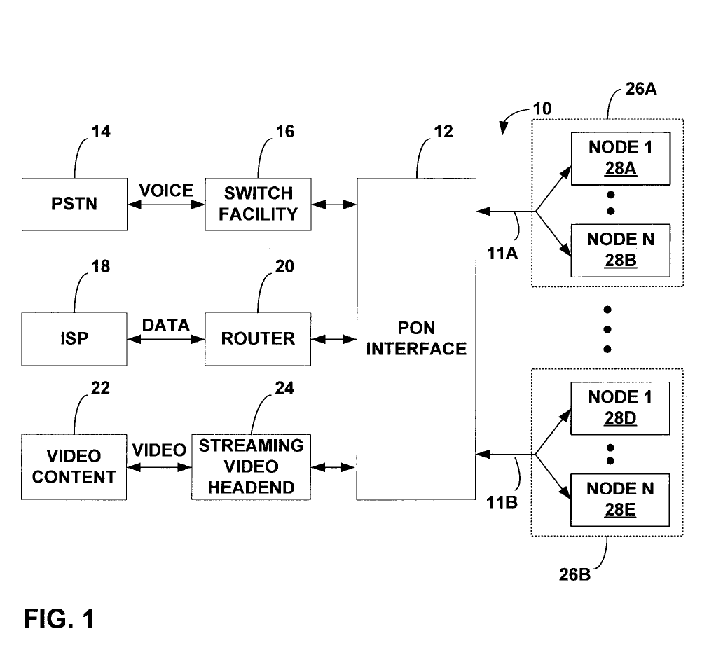

FIG. 1 is a block diagram illustrating a passive optical network (PON) 10. PON 10 can be arranged to deliver voice, data and video content (generally “information”) to a number of network nodes via optical fiber links 11. For example, a PON interface 12 may receive voice information from the public switched telephone network (PSTN) 14 via a switch facility 16. In addition, PON interface 12 may be coupled to one or more Internet service providers (ISPs) 18 via a router 20.

As further shown in FIG. 1, PON interface 12 may receive video content 22 from video content suppliers via a streaming video headend 24. In each case, PON interface 12 receives the information, and distributes it along optical fiber links 11A and 11B (collectively optical fiber links 11) to groups 26A and 26B (collectively groups 26) of network nodes 28A, 28B, 28C and 28D (collectively nodes 28). Each of groups 26 is coupled to a particular one of optical fiber links 11.

Furthermore, each of optical fiber links 11 may be connected to a particular interface module of PON interface 12. In this manner, respective interface modules of PON interface 12 and groups 26 of network nodes 28 terminate opposite ends of optical fiber links 11 in order for communication between PON interface 12 and network nodes 28. PON interface 12 may be coupled to any number of fiber links 11. Accordingly, FIG. 1 shows only two fiber links 11A, 11B for purposes of illustration.

Network nodes 28 include hardware for receiving information from PON 10 via optical fiber links 11, and delivering the information to one or more devices associated with respective network nodes 28. For example, each of network nodes 28 may serve as a PON access point for one or more computers, network appliances, televisions, set-top boxes, wireless devices, or other similar devices. PON interface 12 may be located near or far from a group 26 of network nodes 28. In some existing networks, however, PON interface 12 may reside in a central office situated within approximately ten miles from each of network nodes 28.

A network node 28 may be located at any of a variety of locations, including residential or business sites. In addition, a single network node 28 may operate on a shared basis to deliver information to two or more closely located residences or businesses via copper or additional optical fiber connections, either directly or via a network hub, router or switch. A group 26 of network nodes 28 may refer to nodes served by PON interface 12 via a common optical fiber link 11. Each group 26 in FIG. 1 contains two network nodes 28 for purposes of illustration. However, a group 26 may include a single network node 28, or numerous network nodes 28.

Network nodes 28 also may include hardware for transmitting information over PON 10. For example, a network node 28 may transmit voice information over PSTN 14 via PON interface 12 and switch facility 16 in the course of a telephone conversation. In addition, a network node 28 may transmit data to a variety of network nodes on the Internet via ISP 18, router 20 and PON interface 12. Multiple network nodes 28 typically transmit over a common optical fiber link 11 using time division multiplexing techniques.

As described above, each of network nodes 28 may serve as a PON access point for one or more devices. Each of the devices to which network nodes 28 serve as a PON access point have a network address, such as an Internet Protocol (IP) address, that is used to route packets within a local area network (LAN) of the PON. In this manner, numerous IP addresses may correspond to a single network node 28. The IP addresses may be IPv4 addresses, IPv6 addresses, or a combination thereof.

Network nodes 28 in different groups 26 served by different optical fiber links 11 may be assigned IP addresses within a common subnet scope, thereby conserving IP addresses and promoting increased IP address usage. PON interface 12 maintains routing information and stores the routing information in an archive. The routing information may be used to route traffic to appropriate interface modules of PON interface 12. More specifically, the routing information associates IP addresses assigned to the devices served by network nodes 28 with corresponding interface modules of PON interface 12.

In general, as will be described, PON interface 12 uses the Dynamic Host Configuration Protocol (DHCP) protocol to assign IP addresses and create Layer-3 routing information, i.e., routing information mapping IP addresses to interface modules, for PON 10. In accordance with the invention, PON interface 12 monitors communications between a DHCP server and a DHCP client, i.e., a device served by a network node 28, and generates routing information that maps each interface module of PON interface 12 with an associated set of IP addresses based on the monitored communications.

The techniques used to generate the routing information allow PON 10 to associate DHCP assigned IP addresses across its network as well as establish corresponding routing of IP packets across its network. The techniques work within the DHCP protocol of the client and server, and can be labor saving because there is a reduced need for manual administration of IP address routing. In addition, the techniques allow routing to be established between individual nodes 28 and interface modules of PON interface 12 by monitoring the dialog of the commonly known DHCP protocol.

Because the techniques of the invention operate at Layer 3, i.e., the network layer, the routing information provides PON 10 with more efficient routing. In particular, Layer 2 information, i.e., data link layer information, does not need to be carried across PON 10. Also, this technique enables the use of Layer 3 security methods, and lower cost switching methods associated with Layer 3 switching and routing. In addition, the technique provides ease of administration because Layer 2 methods of routing, such as Virtual Local Area Network (VLAN) tagging, are not required. The techniques further allow for non-repudiation of traffic origination, and isolation of IP traffic anomalies to a specific interface. In general, for a PON access network using DHCP Boot-Relay for IP address assignment to clients, this technique provides a way for the access network to establish DHCP IP address routing information to specific PON interface modules.

Exemplary components for implementing PON 10 are commercially available from Optical Solutions, Inc., of Minneapolis, Minn., and designated by the tradename Fiberpath 400™, including the Fiberdrive™ headend bay interface and the Fiberpoint™ subscriber premise nodes.

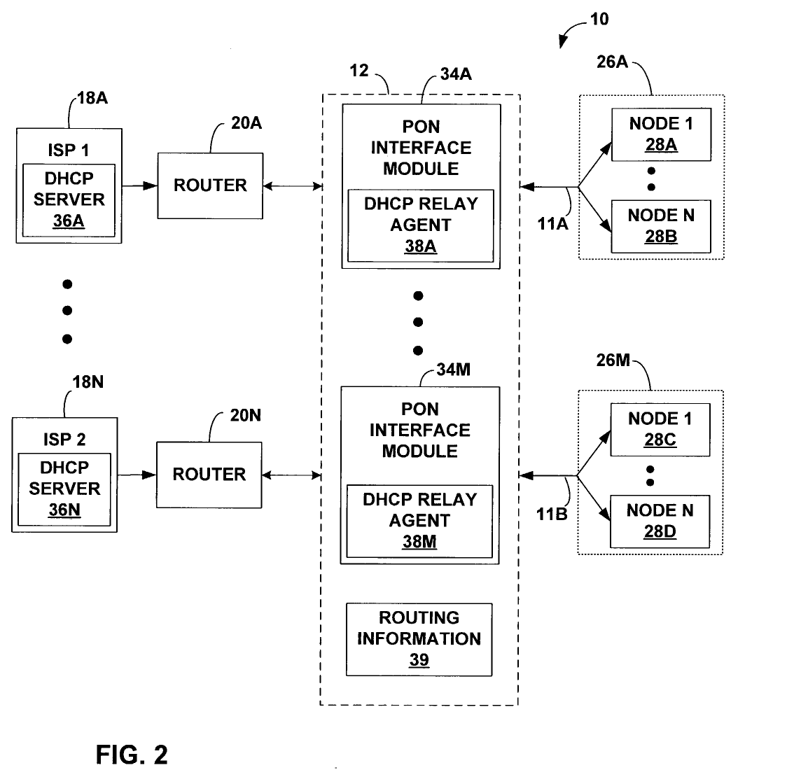

FIG. 2 is a block diagram illustrating a PON 10 with groups 26 of network nodes 28 coupled to multiple PON interface modules 34A-34M (collectively interface modules 34) within PON interface 12. PON interface 12 may include multiple PON interface modules 34, e.g., arranged in a common chassis. Each PON interface module 34 may form an independent Ethernet interface that serves a group 26 of network nodes 28 coupled to a common optical fiber link 11. Hence, PON interface module 34 and network nodes 28 terminate opposite ends of optical fiber link 11.

Each of PON interface modules 34 may further incorporate a respective DHCP relay agent 38A-38N (collectively DHCP relay agents 38) that passes DHCP messages between a DHCP client represented on one of network nodes 28 and one of DHCP servers 36A-36N (collectively DHCP servers 36), which may be maintained by respective ISPs 18. For example, DHCP relay agents 38 may generate DHCP proxy requests, and transmit the requests to DHCP servers 36 for the group 26 of network nodes 28 served by the respective PON interface module 34.

In some embodiments, an optical fiber link 11 may include a pair of optical fibers, forming an outgoing link and an incoming link. As shown in FIG. 2, PON interface modules 34 receive information from one or more ISPs 18A-18N (collectively ISPs 18) via network routers 20A-20N (collectively routers 20), and transmit the information to network nodes 28 via optical fiber link 11. As a result, different ISPs 18 can serve network nodes 28 via a common optical fiber link 11, providing the DHCP clients with a choice among two or more of ISPs 18. Similarly, PON interface modules 34 receive information from network nodes 28, and transmit the information to one or more of ISPs 18 via respective ones of routers 20.

PON 10, illustrated in FIG. 2, may use DHCP relay techniques to provide IP addresses to clients represented on network nodes 28. In accordance with the invention, PON interface 12 associates a DHCP obtained IP address for a client with a respective PON interface module 34 on which the client resides and generates routing information to reflect the associations. For example, DHCP relay agent 38 monitors DHCP communications between DHCP servers 36 and the DHCP clients of network nodes 28 and updates the routing information that associates each PON interface module 34 with an associated set of IP addresses based on the monitored DHCP communications.

Routing IP packets between PON interface 12 and network nodes 28 may be based on the association gleaned from monitoring DHCP relay dialog between DHCP servers 36 and the DHCP clients of network nodes 28. By monitoring the DHCP IP address assignment given to a client by the DHCP server that administers IP addresses to the client, a unique routing path through a PON may be constructed. This association between the assigned IP address and respective PON interface module 34 exists for the duration of the DHCP defined lease or until the client releases the IP address per the protocol.

More specifically, when a DHCP client wants to obtain an IP address, it broadcasts a DHCP request on a corresponding LAN segment that is attached to the Ethernet device of the respective network node 28. The DHCP client device may want to obtain an IP address upon reboot or upon expiration of a previously leased IP address. Network node 28 may forward the DHCP request to PON interface 12 via the PON. The DHCP request protocol includes information that makes the request unique to the DHCP client. For example, the DHCP request may include a media access control (MAC) address of the client device.

PON interface 12 uses the information to create a mapping between the unique information from the DHCP request, e.g., the MAC address of the client device, and PON interface module 34 on which the DHCP client resides. For example, if a client device that resides on node 28A of group 26A sends the DHCP request, PON interface 12 creates a mapping that associates the MAC address of the DHCP client device of node 28A with PON interface module 34A. PON interface 12 forwards the DHCP request to the provisioned DHCP server 36 via the respective DHCP relay agent 36 of PON interface module 34. The DHCP request may be provisioned with DHCP relay parameters such as a particular DHCP server 36 and a gateway address to which the DHCP request should be forwarded.

PON 12 receives a DHCP response from the respective DHCP server 36 and determines the particular PON interface module 34 to which to forward the DHCP response. The DHCP response may contain information, such as the MAC address of the destination DHCP client device, which PON interface 12 inspects to determine the appropriate PON interface module 34 for forwarding of the packet. Particularly, PON 12 determines the appropriate PON interface module 34 for forwarding the packet using the mapping that associates the MAC address of the client device with a respective PON interface module 34.

The IP address administered in the DHCP response, i.e., leased to the requesting DHCP client, may be used to update the mapping to create routing information 39 on PON interface 12 for forwarding packets. Specifically, PON interface 12 may update the mapping to associate the IP address leased to the DHCP client with a respective PON interface module 34. In this manner, routing information 39 is updated so that the PON interface modules 34 on PON interface 12 represent the administered IP address when associated routing entities are forwarding data to the specified IP address. In other words, PON interface 12 routes communications through PON 10 in accordance with routing information 39.

PON interface 12 forwards the DHCP response to network node 28 that represents the DHCP client making the request. Network node 28 forwards the DHCP response to the original requesting DHCP client. Network node 28 may also use the administered IP address, and other information contained in the DHCP response, such as an IP subnet scope, to determine whether forwarding of packets inside the IP address space scope of the DHCP client should be done by network node 28 or whether the DHCP client device is trying to communicate with devices that are locally attached. For example, network node 28 may only forward addresses that are within the IP subnet scope indicated within the response.

The DHCP response also contains lease-time information that may be monitored. The lease time determines the amount of time the requesting DHCP client may use the allocated IP address. PON interface 12 monitors all DHCP protocol traffic between respective DHCP servers 36 and DHCP clients. Monitoring traffic between DHCP servers 36 and the client allows PON 12 to identify leasing events, such as the DHCP client releasing the administered IP address, attempting to renew the lease time, or DHCP server 36 declining the renewal of the IP address.

If the address is released, for instance, PON interface 12 may update routing information 39 to delete the representation of the path to the former DHCP client for which the IP address was administered. In other words, PON interface 12 may delete the mapping of the administered IP address to respective PON interface module 34 from routing information 39. In the event that the DHCP client does not renew the address within the lease time period, the administered IP address will be removed from routing information 39 maintained by PON interface 12 upon expiration of the lease time period.

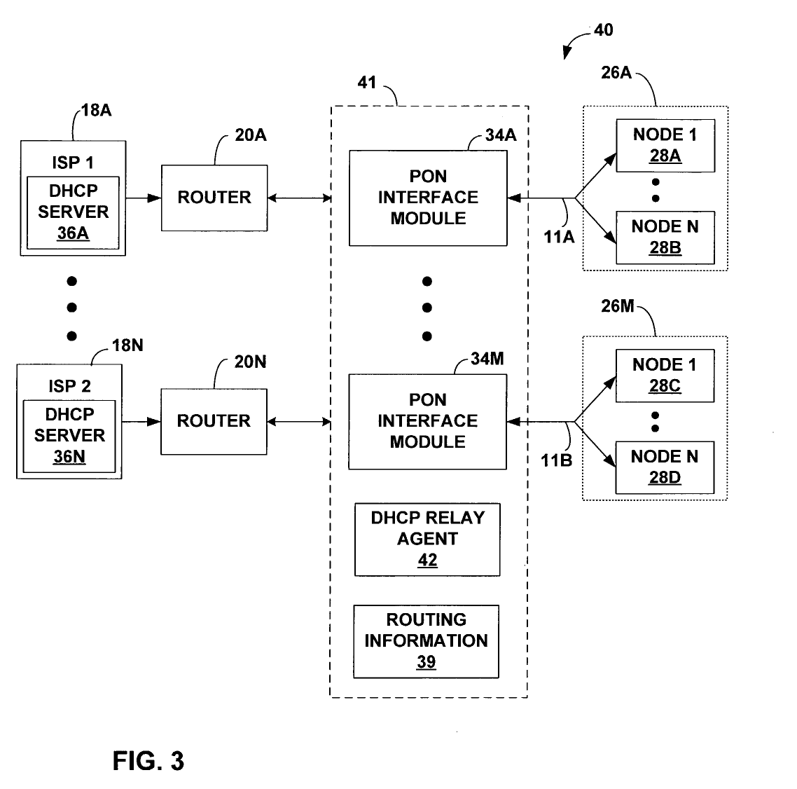

FIG. 3 is a block diagram illustrating another exemplary PON 40. PON 40 conforms substantially to PON 10 illustrated in FIG. 2, but PON 40 includes a PON interface 41 in which PON interface modules 34 each correspond to a common DHCP relay agent 42. In this manner, a single DHCP relay agent 42 passes DHCP messages between a DHCP clients represented on network nodes 28 and DHCP servers 36 for all of PON interface modules 34 of PON interface 41. Further, DHCP relay agent 42 updates routing information 39 upon identifying DHCP communications that include network address lease information.

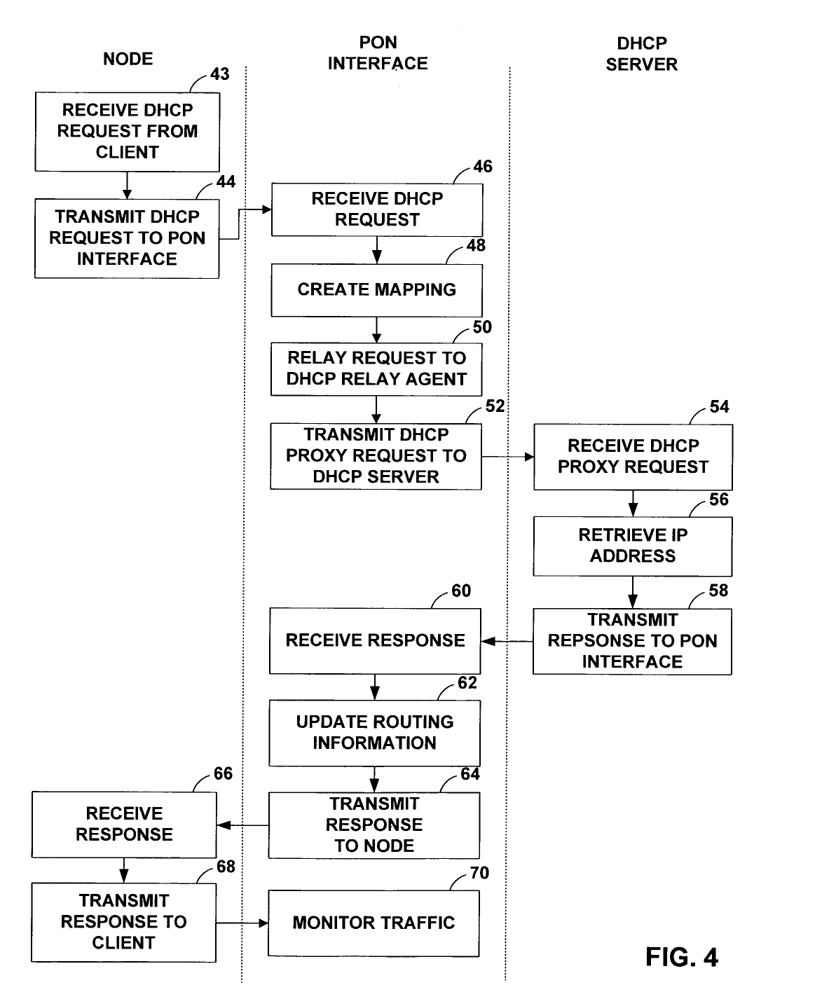

FIG. 4 is a flowchart illustrating interaction of various PON components to create and maintain routing information, such as routing information 39 (FIG. 2), in accordance with the invention. Network node 28 receives a DHCP request for an IP address from a DHCP client represented by the particular network node 28, and transmits the DHCP request to PON interface 12 via PON 16 (43, 44). For example, upon reboot or lease expiration, the DHCP client may broadcast a DHCP request on a corresponding LAN segment attached to network node 28.

PON interface 12 and, more specifically, a respective one of PON interface modules 34 receives the DHCP request from network node 28 (46). The DHCP request may include information, such as a MAC address, that is unique to the requesting DHCP client. PON interface 12 creates a unique mapping based on the client information contained in the DHCP request and PON interface module 34 on which the client resides, i.e., PON interface module 34 that received the DHCP request (48). For example, PON interface 12 may create a mapping that associates MAC addresses corresponding to DHCP clients of network nodes 28 with respective PON interface modules 34 associated with network nodes 28.

PON interface module 34 relays the request to a DHCP relay agent 38 (50). DHCP relay agent 38 may be a centralized DHCP relay agent that communicates traffic between network nodes 28 and DHCP servers 36 for all of PON interface modules 34. Alternatively, each PON interface module 34 may incorporate a DHCP relay agent 38. The DHCP request may further contain relay parameters that specify a particular one of DHCP servers 36 to receive the request, or a particular gateway address. DHCP relay agent 38 transmits a DHCP proxy request to the appropriate DHCP server 36 on behalf of the requesting DHCP client (52).

Upon receipt of the DHCP proxy request, DHCP server 36 retrieves an IP address from a pool of available IP addresses within the selected subnet scope reserved by the corresponding ISP 18 (54, 56). DHCP server 36 then transmits a DHCP response, which contains an IP address lease, to PON interface 12 (58). The response specifies an IP address and a duration for which the IP address will remain in force for the requester. The response may further include an IP address subnet scope, MAC address of the requesting DHCP client, or other information related to the lease.

Upon receipt of a DHCP response from DHCP server 36, PON interface 12 determines which of PON interface modules 34 receives the forwarded DHCP response (60). For example, PON interface 12 may extract a MAC address of the requesting DHCP client from the DHCP response and inspect the mapping of MAC addresses to PON interface modules 34 to determine the appropriate PON interface module 34 to route the packet to. Furthermore, PON interface 12 may update the mapping in order to generate routing information that associates the IP address administered in the response with the respective PON interface module 34 for routing packets (62). For example, PON interface may generate routing information to map a particular IP address to an appropriate PON interface module 34. In this manner, PON 12 creates routing information that may be used to route incoming packets to an appropriate PON interface module within PON interface 12 and thus for forwarding data to specified destination IP addresses.

PON interface 12 forwards the DHCP response to network node 28 representing the DHCP client via the appropriate one of PON interface modules 34 in accordance with the routing information (64). Network node 28 receives the response from the respective PON interface module 34, and forwards the response to the requesting DHCP client (66, 68). Network node 28 uses information contained in the DHCP response to determine the appropriate DHCP client to forward the packet to.

For example, the DHCP response may include a MAC address of the DHCP client, which network node 28 uses to forward the packet destined for the DHCP client. Network node 28 may further use information, such as the administered IP address and IP subnet scope, contained in the response for routing packets sourced from the DHCP client. For example, a DHCP client may send a packet to a printer device that is locally attached. Network node 28 realizes that the communication from the DHCP client is to a locally attached device, and does not forward the packet to PON 10.

PON interface 12 continues to monitor traffic between the DHCP client on network node 28 and DHCP server 36 in order to maintain accurate routing information (70). Because each administered IP address has a lease time, PON interface 12 may monitor DHCP traffic to ensure the accuracy of the routing information. For example, in the event that the DHCP client releases the IP address, PON interface 12 may update routing information to reflect the change. Furthermore, PON interface 12 may track the lease time for an administered IP addresses. In this case, PON interface 12 may update routing information upon expiration of the lease period. When tracking lease times it may be important to monitor DHCP traffic to update lease times in the event the client renews the lease of the administered IP address.

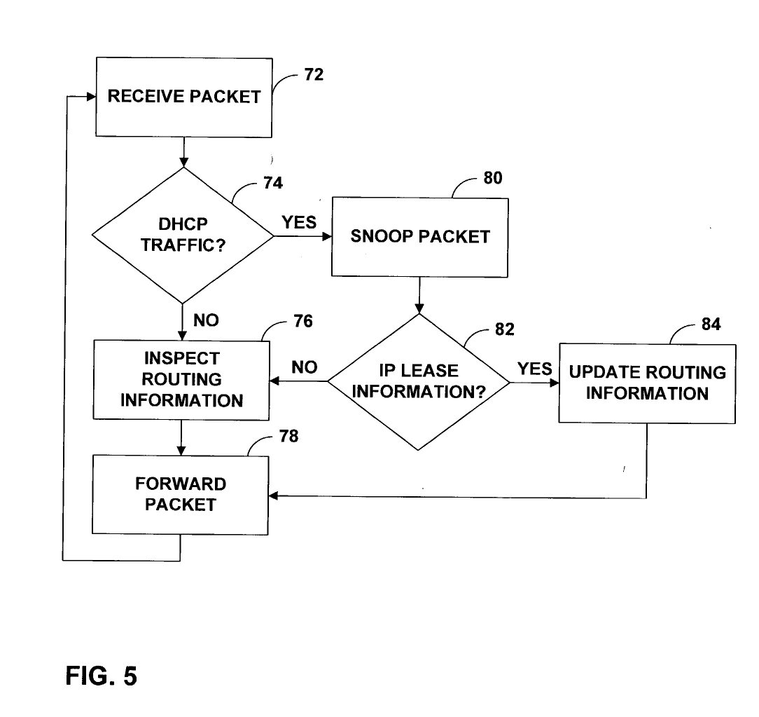

FIG. 5 is a flowchart illustrating an exemplary mode of operation of PON interface 12 handling an inbound packet. PON interface 12 receives an inbound packet (72). The inbound packet may be from a DHCP client represented on one of network nodes 28 or from an ISP 18. PON interface 12 determines whether the packet contains DHCP communications (74). When the packet does not contain DHCP communications, PON interface 12 inspects routing information to determine which of PON interface modules 34 should receive packet (76). PON interface 12 forwards the packet to the appropriate PON interface module 34 in accordance with the routing information (78). PON interface module 34 forwards the packet to network nodes 28, and the particular network node 28 that represents the destination address of the packet retrieves the packet from PON 10 and forwards the packet to the DHCP client associated with the destination address.

When the packet contains DHCP communications, such as DHCP requests and responses, PON interface 12 checks the contents of the packet for information regarding the lease of IP addresses, a process referred to as snooping (80, 82). When the packet contains any sort of IP lease information, PON interface 12 updates the routing information to reflect changes in the IP lease information (84). For example, if a new IP address lease is administered, routing information may be updated to map the administered IP address to a specific PON interface module 34 that represents a DHCP client that leases the IP address contained in the DHCP request. When the packet does not contain information regarding the lease of IP addresses, PON interface 12 inspects the routing information to determine a path for forwarding the packet and forwards the packet is forwarded in accordance with the routing information (78).

Various embodiments of the invention have been described. Although the exemplary embodiments are described in terms of assigned IP addresses, devices served by network nodes may be assigned other types of network addresses used to route packets to and from the devices. Additionally, although the techniques of the invention are described in terms of DHCP, the techniques may be applied to optical networks that use other communication protocols for assigning network addresses to clients, such as Bootstrap Protocol (BOOTP). These and other embodiments are within the scope of the following claims.

1. A method comprising:
monitoring communications between one or more servers and clients of a passive optical network;
generating routing information to associate each of the clients with respective interface modules of a passive optical network interface based on the monitored traffic, the passive optical network interface communicatively coupling the servers and the clients; and
routing traffic within the passive optical network in accordance with the generated routing information.

2. The method of claim 1, wherein monitoring communications comprises:
receiving communications;
identifying whether the communications contain network address lease information; and
updating the routing information in response to identifying network address lease information within the communications.

3. The method of claim 2, wherein the network address lease information includes one of information identifying a new network address lease, renewal of a network address lease, release of a current network address lease, and expiration of a network address lease.

4. The method of claim 1, further comprising:
receiving a request from one of the clients to obtain a network address from one of the servers, the request including information that identifies the requesting client;
mapping the information that identifies the requesting client to a particular one of the interface modules of the passive optical network interface; and
relaying the request to one of the servers.

5. The method of claim 4, wherein the information identifying the requesting client comprises a media access control (MAC) address.

6. The method of claim 4, further comprising:
receiving a response from the server indicating an administered network address; and
generating routing information that associates the administered network address with the interface module associated with the requesting client.

7. The method of claim 6, wherein generating routing information comprises updating the mapping.

8. The method of claim 1, wherein generating routing information to associate each of the clients with respective interface modules of the passive optical network interface based on the monitored traffic includes generating routing information to associate network addresses leased to the clients with respective interface modules of the passive optical interface based on the monitored traffic.

9. The method of claim 8, wherein the network address comprises an Internet Protocol (IP) address.

10. The method of claim 1, wherein the communications comprise dynamic host configuration protocol (DHCP) communications.

11. The method of claim 1, wherein the communications comprise bootstrap protocol (BOOTP) communications.

12. An interface for coupling one or more servers to clients within a passive optical network, the interface comprising:
a plurality of interface modules to transmit information to the clients via a plurality of optical fiber links, each of the interface modules corresponding to a particular one of the optical fiber links; and
an archive storing routing information that associates each of the clients with respective ones of the interface modules in order to route traffic to the clients, wherein the interface monitors communications between the clients and the servers in order to generate the routing information.

13. The interface of claim 12, wherein the interface receives the communications, identifies whether the communications contain network address lease information, and updates the routing information in response to identifying network address lease information within the communications.

14. The interface of claim 13, wherein the network address lease information includes information identifying one of a new network address lease, a renewal of a network address lease, a release of a current network address lease, and an expiration of a network address lease.

15. The interface of claim 12, wherein the interface receives a request from one of the clients to obtain a network address from one of the servers, maps information within the request that identifies the requesting client to a particular one of the interface modules of the interface, and relays the request to one of the servers.

16. The interface of claim 15, wherein the information within the request that identifies the requesting client comprises a media access control (MAC) address.

17. The interface of claim 15, wherein the interface receives a response to the request from the server indicating an administered network address and generates routing information that associates the administered network address with a respective one of the interface modules of the interface.

18. The interface of claim 12, wherein the interface generates routing information to associate leased network addresses corresponding to the clients with respective interface modules of the interface based on the monitored traffic.

19. The interface of claim 18, wherein the network addresses comprise Internet Protocol (IP) addresses.

20. The interface of claim 12, wherein the communications comprise dynamic host configuration protocol (DHCP) communications.

21. The interface of claim 12, wherein the communications comprise bootstrap protocol (BOOTP) communications.

22. A passive optical network comprising:
a plurality of network nodes to provide passive optical network services to one or more clients;
at least one server to assign network addresses to the clients of the network nodes;
an interface that includes a plurality of interface modules to transmit information to subsets of the network nodes, wherein the interface stores routing information that associates each of the interface modules with the clients of the respective subsets of network nodes.

23. The passive optical network of claim 22, wherein the interface monitors communications between the clients and the server and generates the routing information based on the communications.

24. The passive optical network of claim 23, wherein the interface receives the communications, identifies whether the communications contain network address lease information, and updates the routing information in response to identifying network address lease information within the communications.

25. The passive optical network of claim 24, wherein the network address lease information includes information identifying one of a new network address lease, a renewal of a network address lease, a release of a current network address lease, and an expiration of a network address lease.

26. The passive optical network of claim 23, wherein the communications comprise dynamic host configuration protocol (DHCP) communications.

27. The passive optical network of claim 23, wherein the communications comprise bootstrap protocol (BOOTP) communications.

28. The passive optical network of claim 22, wherein the interface receives a request from one of the clients to obtain a network address from the server, maps information within the request that identifies the requesting client to a particular one of the interface modules of the interface, and relays the request to the server.

29. The passive optical network of claim 28, wherein the interface receives a response to the request from the server indicating an administered network address and generates routing information that associates the administered network address with a respective one of the interface modules of the interface.

30. The passive optical network of claim 22, wherein the network addresses comprise Internet Protocol (IP) addresses.
